(19) United States
(12) Patent Application Publication
(10) Pub. No.: US 2005/0129894 A1
(43) Pub. Date: Jun. 16, 2005

(54) Flexible plastic or vinyl sheeting coated with adhesive for refinishing

(75) Inventor: William Sobonya, Westlake, OH (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: Henkel Consumer Adhesives, Inc.

(21) Appl. No.: 10/736,871

(22) Filed: Dec. 16, 2003

(51) Int. Cl. B32B 7/12

(52) U.S. Cl. 428/40.1; 428/343

(57) ABSTRACT

An adhesive covering for articles, particularly articles of furniture. The covering comprises a high-shrink, stretchable plastic or vinyl film having a textured finish embossed to one side of the plastic or vinyl film. A contact adhesive is provided on the bottom side of the embossed film, and a removable protective covering protects the contact adhesive. When the protective covering is removed and the adhesive covering is applied around an edge of the article with a small amount of stretching force, the covering adapts to a contour of the edge without leaving a gap between the contact adhesive and the article.

This invention relates to embossed films, with adhesive, used as a covering, for example, as shelf liners or for refinishing articles.

### BACKGROUND OF THE INVENTION

Currently available coverings are often adhesive sheets which are adhered with a contact-type adhesive directly to the surface to be covered. These liner products are generally offered to consumers in roll form and must be cut to proper size to fit the dimensions of a surface, such as a shelf or tabletop. Once cut, the product is adhered with the adhesive to the surface of the article being covered.

The benefits of using any covering such as vinyl adhesive sheets reside primarily in offering an inexpensive but decorative surface to the article while simultaneously providing a protective layer which will prevent damage, such as, for example, water damage to the shelf structure itself. Among the problems of present covering products, particularly when refinishing articles of furniture, is that it is difficult to cut the covering to precisely match and correctly align with the edges of the surface being covered. The result is oftentimes undesirable in appearance with the covered article having uncovered, exposed edges. Even if the covering is cut correctly and properly aligned with the edges, if the adjoining surface is also being covered, there remains an unsightly seam at the joining edges. A further problem for a covering that is stiff is that the result is oftentimes a surface with wrinkles or bubbles as a result of the unforgiving, inflexible properties of the covering.

### SUMMARY OF THE INVENTION

It is the principle object of the invention to provide a covering or liner which overcomes the deficiencies of the prior art.

Another object of the invention is to provide a covering material which is easy to install onto a surface of an article, yet provides a decorative, wrinkle free surface with a reduced number of seams at edges of the article.

Still another object of the invention is to provide a covering material which is thick enough to provide a durable surface while, at the same time, providing a decorative wood-like appearance with a reduced number of seams at edges of the article.

In accordance with the present invention, there is provided a consumer product comprising an adhesive covering for articles, particularly articles of furniture. The covering comprises a high-shrink, stretchable plastic or vinyl film that has a textured finish embossed to one side of the plastic or vinyl film, preferably the bottom side. A contact adhesive is provided on the bottom side of the embossed film, and a removable protective covering protects the contact adhesive. When the protective covering is removed and the adhesive covering is applied around an edge of the article with a small amount of stretching force, the covering adapts to a contour of the edge without leaving a gap between the contact adhesive and the article.

In accordance with another aspect of the present invention, there is provided a method for covering an article having at least one edge. According to the method, an adhesive covering as described above is trimmed to an approximate size. The protective covering is removed from the trimmed adhesive covering, and the trimmed adhesive covering is contacted with a first side of the article. The trimmed covering is then stretched over the edge of the article and contacted with a second side of the article.

In the preferred embodiment, the surface finish is applied to the bottom of the film. The film is transparent and the top of the film is smooth. The body of the film protects the embossed surface finish, such as the exemplary wood-like texture.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof and wherein:

FIG. 1 is a top plan view, with a layer folded back to reveal layers of a portion of an adhesive covering in accordance with the invention;

FIG. 2 is a sectional side view of the covering of FIG. 1 showing details of the laminated elements, in accordance with the invention;

FIG. 3 is a perspective view of an adhesive covering in a pre-assembled state prior to application to multiple adjoining surfaces in accordance with prior art;

FIG. 4 is a perspective view of an adhesive covering depicting an application technique to multiple adjoining surfaces in accordance with techniques of the present invention;

FIG. 5 is a perspective view of an adhesive covering depicting an alternate application technique to multiple adjoining surfaces in accordance with techniques of the present invention;

FIG. 6 is a perspective view of an applied adhesive covering in accordance with the present invention; and

FIG. 7 is a perspective view of an applied adhesive covering having heat applied in accordance with methods of the present invention; and

FIG. 8 is a schematic depicting a manufacturing process in accordance with the invention.

### DESCRIPTION OF THE PREFERRED EMBODIMENT

Reference is now made to the drawings wherein the showings are for the purpose of illustrating a preferred embodiment of the invention only and not for the purpose of limiting same. The present invention comprises an embossed film simulating a wood finish, with adhesive for lining shelves, drawers and other articles.

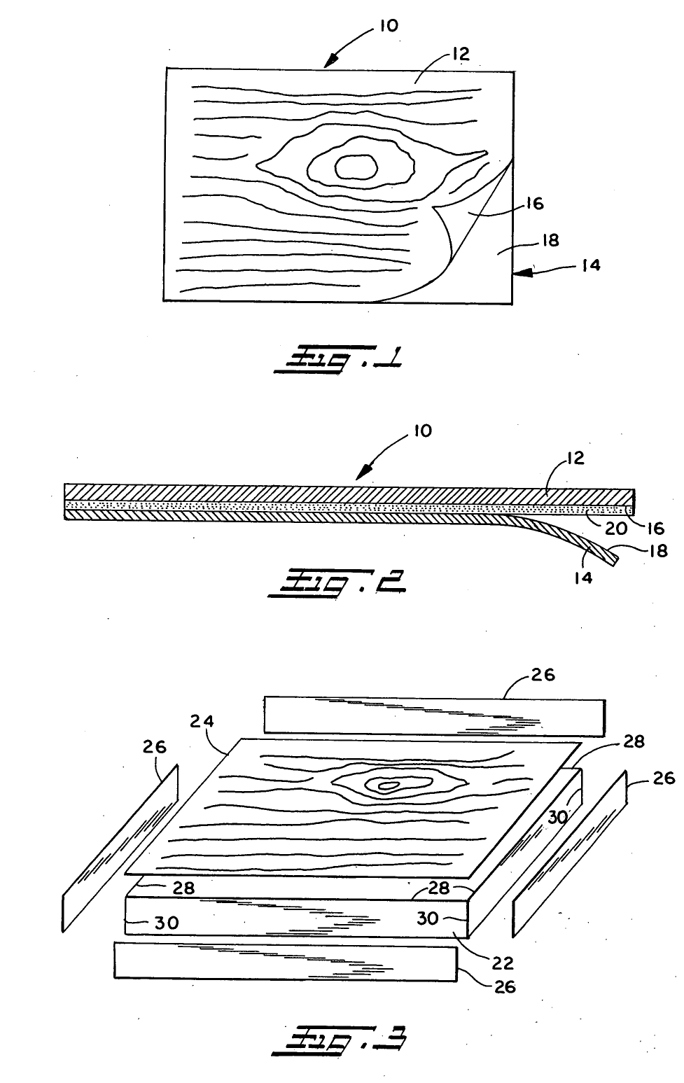

Referring to FIG. 1, the embossed, adhesive covering 10 of a preferred embodiment of the present invention includes an embossed film 12, embossed to simulate a wood texture as shown, adhered to a removable protective covering 14. In the preferred embodiment, a surface finish is applied to the bottom (back) surface of the film. The film is transparent and the top of the film is smooth. The body of the film protects the embossed surface finish, such as the exemplary wood-like texture. The back surface 16 is coated with a layer of adhesive 20. The protective covering 14 is preferably a paper material that may be peeled back from the adhesive 20 as shown in the figure. The top surface 18 of the protective covering that is in contact with the adhesive 20 is preferably coated with a release coating so that it does not adhere permanently to the adhesive 20 and may be easily peeled back from the adhesive. The covering 10 is cut by the consumer to a desired size and shape. The protective covering is removed and the cover is applied to the supporting surface.

The embossed film 12 includes a back surface 16 which is adhered to the top surface 18 of the removable lining as also shown in sectional view in FIG. 2. Preferably, the embossed film is adhered with an aggressive, permanent pressure sensitive contact adhesive 20 for adhering the covering 10 to a surface after the removable lining 14 is removed. Suitable adhesives are available from Henkel Adhesives, 1347 Gasket Drive, Elgin, Ill. 60120.

The textured, embossed film 12 of FIG. 1 is preferably made of a vinyl or plastic, high-shrink, stretchable material that is thick enough for embossing a realistic wood-like finish and simultaneously suitable for covering a supporting surface such as, for example, a shelf surface. For example, prior art shelf coverings typically use a 3-5 mil sheets, whereas the above-described preferred embodiment utilizes a much thicker 7 to 10 mil embossed vinyl sheet. The embossed film can be other suitable, high-shrink, stretchable materials known in the art, provided the material is non-porous, waterproof and thick enough to be embossed with the wood-like finish. The exemplary embossed pattern is a combination of coloring and texturing which makes a non-wood surface look like a natural wood surface. Such surface finishes are commercially available. The preferred vinyl material is suitable for incidental food contact while also providing a convenient surface for sliding articles such as, for example, dishware, china and vases.

The covering 10 is preferably flexible and can be rolled or folded, although a rolled configuration is preferable. The covering can also be cut to the desired dimensions by use of household scissors, such as, for example, those of the supporting surface without destroying the integrity of the cover.

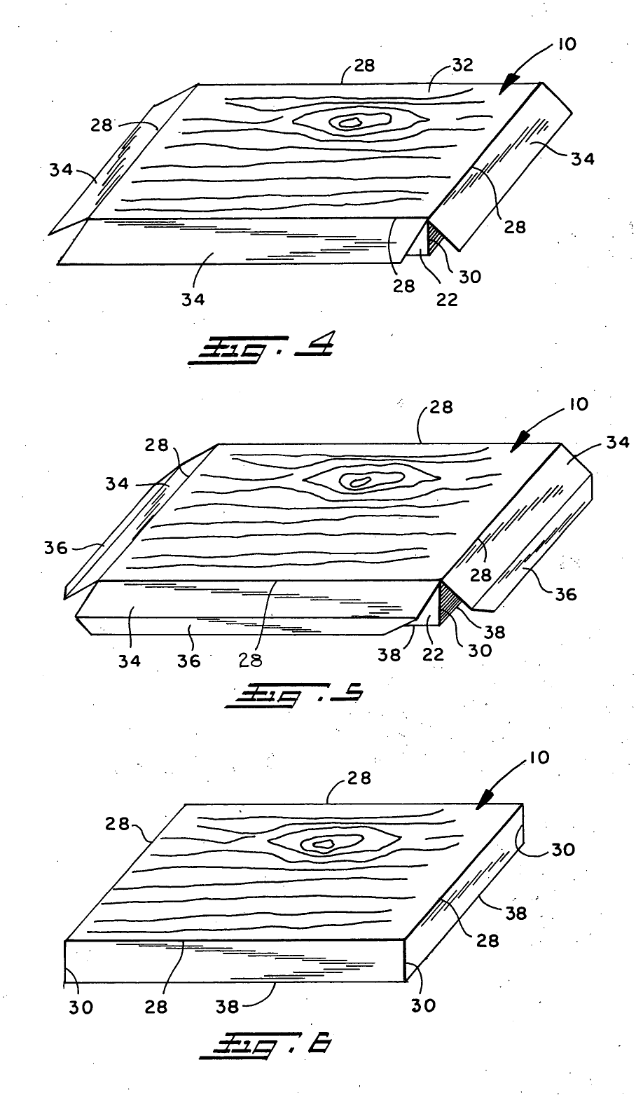

FIG. 3 illustrates a method of covering an article 22 with a covering according to prior art. A top piece 24 is cut, applied and trimmed if necessary. Similarly, side pieces 26 are then cut, applied and trimmed as necessary. The resulting covered article, however, will show covering joints or seams along the top edges 28 and the corners 30. In order that the finished covered article has a pleasing appearance, it is necessary that the covering 26 at the edges 28 and corners 30 be trimmed and fit very precisely. This is a difficult and time-consuming process which, even if done correctly still shows exposed edges of the covering 26 at the top edges 28 and corners 30.

A principle advantage of the high-shrink, stretchable embossed lining 12 of the present invention is illustrated in FIG. 4. For example, as shown, a covering 10 has been cut to a size sufficient to cover not only the top surface of the article 22 with a top portion 32, but also the sides with side portions 34 of the covering 10. The covering 10 top portion 32 is first applied to the top surface, and then stretched and pulled downward as the side portions 34 are applied to the sides of the article 22. The end result is that there are no visible seams along the top edges 28. Because of the high-shrink, flexible nature of the covering 10, the covering 10 also fits tightly at the edges 28, preserving the shape of the original sharp edges with minimal rounding. If this were attempted with prior art coverings, there would likely be rounding of the covering with subsequent lifting or separation from the surface of the article, resulting in unsightly edges.

A further advantage of the high-shrink, stretchable cover 10 is that, even when the bottom side of an article is not being covered, the covering 10, as shown in FIG. 5, maybe cut with excess portions 36 that can be stretched and wrapped around the bottom edges 38 and attached to a portion of the bottom of the article 22. The advantage being that there is reduced risk of the bottom edge of the covering being peeled off of the article 22 during subsequent use of the covered article. Another advantage provided is that the bottom edges need not be trimmed precisely since the excess portions 36, in this example, are not exposed, and the bottom edges 38 will have a pleasing appearance.

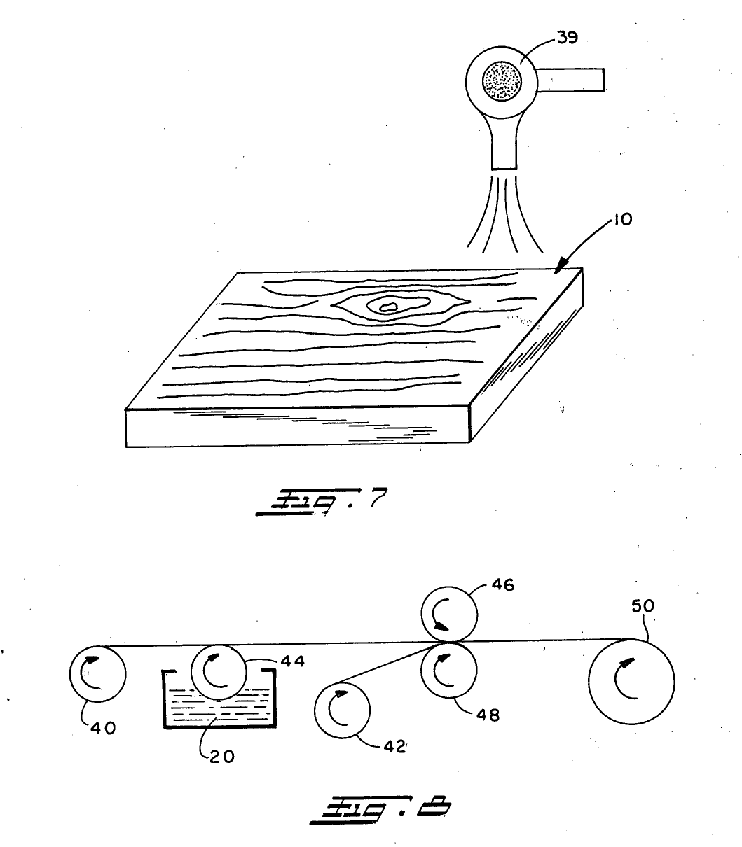

FIG. 6 shows the above-described, exemplary, finished, covered article according to methods of the present invention, where the covering 10 has seams only along the corners 30. There are no remaining seams in this example, either along the top edges 28 or along the bottom edges 38. FIG. 7 shows heat being applied to the high-shrink, stretchable cover 10 in order to further reduce or eliminate any remaining wrinkles or bubbles in the cover by further shrinking the cover 10 onto the covered article. An advantageous method for consumers to apply heat to the cover 10 is to use an inexpensive, readily available blow dryer 39.

FIG. 8 illustrates in schematic form a manufacturing process for securing the embossed film 12 to the removable paper 14 using an adhesive 20 for the preferred embodiment as illustrated in FIGS. 1-2. The embossed film 12 is provided on a first feed roll 40 with the decorative embossed finish facing upward with respect to the FIG., away from the roll 40. The paper 14 is provided on a second feed roll 42. The adhesive 20 is coated onto one side of the embossed film 12 by means of a transfer roll 44 or other conventional means. The thickness of the adhesive can be controlled by the viscosity of the adhesive 20 applied to the roll 44 or other known means such as a doctor bar or doctor roll. The adhesive coated embossed film 12 and the removable paper 14 are joined at pinch rollers 46, 48 where the layers are pressed together. The combined layers are taken up on a take-up roll 50.

It may be desirable to coat the adhesive 20 onto the paper 14 rather than the embossed film 12. In such a case, the paper 14 is placed on the first feed roll 40. The embossed film 12 is placed on the second feed roll 42 with the embossed finish placed facing the roll 42, facing toward the bottom side of the figure as the embossed film is drawn from the roll 42.

The embossed film 12 may be treated using any conventional machine to emboss a pattern or design, such as the wood-texture finish for example, on a surface of the film. Such embossed films can be purchased or manufactured as part of making the subject product. This can occur before, during or after the joining process at the pinch rollers 46, 48.

The invention has been described with reference to a preferred embodiment. The invention has also been described with respect to several alternate embodiments. These and other variations and modifications of the invention will occur to others upon the reading and understanding of this specification. It is intended that all such variations, alterations and modifications, be included insofar as they come within the scope of the appended claims or the equivalents thereof.

1. An adhesive covering for articles, said covering comprising
a high-shrink, stretchable film;
a textured finish embossed to one side of said stretchable film;
a contact adhesive applied to a bottom side of said embossed film; and
a removable protective covering applied to the contact adhesive, wherein when said protective covering is removed and said adhesive covering is applied around an edge of said article with a small amount of stretching force, said adhesive covering adapts to a contour of said edge without leaving a gap between said contact adhesive and said article.

2. The adhesive covering as set forth in claim 1, wherein said stretchable film comprises a stretchable vinyl film.

3. The adhesive covering as set forth in claim 1, wherein said stretchable film comprises a stretchable plastic film.

4. The adhesive covering as set forth in claim 1, further including a coating applied to said protective covering between said protective covering and said contact adhesive, wherein said coating does not adhere permanently to said contact adhesive.

5. The adhesive covering as set forth in claim 2, wherein said textured finish is embossed to a bottom side of said stretchable film, between said contact adhesive and said stretchable film.

6. The adhesive covering as set forth in claim 1, wherein textured finish simulates a natural wood texture.

7. The adhesive covering as set forth in claim 1, wherein said contact adhesive is an aggressive contact adhesive.

8. The adhesive covering as set forth in claim 1, wherein said embossed stretchable film has a thickness between 7 and 10 mils (0.18 mm and 0.25 mm).

9. The adhesive covering as set forth in claim 1, wherein said embossed film is suitable for incidental food contact.

10. A method for covering an article having at least one edge, the method comprising:
trimming an adhesive covering as defined in claim 1 to an approximate size;
removing a protective covering from the trimmed adhesive covering;
contacting the adhesive bottom surface of the trimmed adhesive covering to a first side of the article;
stretching the trimmed adhesive covering over the at least one edge of the article; and,
contacting the trimmed adhesive covering to a second side of the article.

11. The method as set forth in claim 10, further including heating the adhesive covering.

12. A method for covering an article having at least one edge, the method comprising:
trimming an adhesive covering to an approximate size, said adhesive covering comprising:
a high-shrink, stretchable film;
a textured finish embossed to one side of said stretchable film;
a contact adhesive applied to a bottom side of said embossed film; and
a removable protective covering applied to said contact adhesive;
removing said protective covering from said trimmed adhesive covering;
contacting said contact adhesive of said trimmed adhesive covering to a first side of said article;
stretching said trimmed adhesive covering over the at least one edge of said article; and,
contacting said contact adhesive to a second side of the article, wherein when said protective covering is removed and said adhesive covering is stretched around said at least one edge of said article, said adhesive covering adapts to a contour of said at least one edge without leaving a gap between said contact adhesive and said article.

13. The method as set forth in claim 12, further including heating the adhesive covering.
